(19) United States
(12) Patent Application Publication
(10) Pub. No.: US 2022/0314478 A1
(43) Pub. Date: Oct. 6, 2022

(54) SHAVING RAZOR CARTRIDGE

(71) Applicant: Bic Violex Single Member S.A., Anoixi (GR)

(72) Inventor: Christos GALANIS, Anoixi (GR)

(73) Assignee: Bic Violex Single Member S.A., Anoixi (GR)

(21) Appl. No.: 17/657,160

(22) Filed: Mar. 30, 2022

(30) Foreign Application Priority Data
Mar. 31, 2021 (EP) 21166273.9

(51) Int. Cl. B26B 21/40; B26B 21/22

(52) U.S. Cl. CPC B26B 21/4031; B26B 21/4018; B26B 21/222; B26B 21/4025

(57) ABSTRACT

A razor cartridge comprises a housing, wherein the housing comprises a group of cutting members arranged between a trailing longitudinal side and a leading longitudinal side along a first shaving direction. The group of cutting members includes at least two forward facing blades, forward facing blades being characterized by facing in the first shaving direction of the razor cartridge. Additionally, the group of cutting members includes at least one backward facing blade, a backward facing blade being characterized by facing opposite to the first shaving direction of the razor cartridge. The at least one backward facing blade, is placed between the at least two forward facing blades, or the at least one backward facing blade, is the cutting member closest to the leading longitudinal side.

This application claims priority from European patent application EP21166273.9, filed on Mar. 31, 2021, its content being incorporated herein by reference.

### TECHNICAL FIELD

The present disclosure relates to shaving razor cartridges and more particularly to shaving razor cartridges comprising blades facing in opposite directions.

### BACKGROUND OF THE DISCLOSURE

Razor cartridges (also known as safety razor cartridges) are usually attached to a shaving razor assembly including a razor handle. In use, a user holds the razor handle and brings the razor cartridge into contact with a portion of skin. By movement of the razor cartridge in a shaving direction, unwanted hair is removed. Users with skin sensitivity issues, as well as issues related to pseudofolliculitis barbae or razor bumps, may have difficulties to shave safely and efficiently with conventional razor assemblies in some situations. Further, users with curly hairs, in particular users prone to pseudofolliculitis barbae, may want to shave hairs from two (different) directions. Shaving hairs from two directions may result in less hairs with sharp tips, which may prevent hair from re-entering the skin. However, shaving in two directions may involve potentially cumbersome rotation of the shaving razor assembly.

More recently, razor cartridge designs allowing shaving in both directions have been developed. These designs usually comprise one group of cutting members arranged to cut in the shaving direction and an adjacently placed second group of cutting members for shaving opposite the shaving direction. Use of these razor cartridges may lead to nicks and cuts, as each group of cutting members may only be supported by its cutting edges. Further, the existing designs may be bulky and thus may feel imprecise to the user.

The performance of razor cartridges may be further improved.

### SUMMARY OF THE PRESENT DISCLOSURE

According to a first aspect, a razor cartridge is provided. The razor cartridge comprises a housing. The housing comprises a group of cutting members arranged between a trailing longitudinal side and a leading longitudinal side along a first shaving direction S.

The group of cutting members includes at least two forward facing blades. A forward facing blade is characterized by facing in the first shaving direction S of the razor cartridge.

Further, the group of cutting members includes at least one backward facing blade. A backward facing blade is characterized by facing opposite to the first shaving direction S of the razor cartridge.

The at least one backward facing blade, may be placed between the at least two forward facing blades, or, alternatively, the at least one backward facing blade, may be the cutting member closest to the leading longitudinal side.

In a second aspect, the present disclosure relates to a shaving razor assembly comprising a razor handle and a razor cartridge according to the first aspect, wherein the razor cartridge is either releasably attached to the razor handle via a pivotable or non-pivotable connection, integrally formed with the razor handle via a non-pivotable connection, or integrally formed with the razor handle via a pivotable connection.

In a third aspect, the present disclosure relates to a kit of parts comprising a razor handle and a razor cartridge holder comprising a plurality of razor cartridges to the first aspect.

Particular examples of the first to third general aspects can be implemented so as to realize one or more of the following advantages.

First, the at least one backward facing blade placed between the at least two forward facing blades may provide additional skin contact points. These skin contact points may reduce the skin bulge and, in turn, prevent nicks and cuts. In particular, skin bumps, for example from advanced pseudofolliculitis barbae may be guided away from the cutting edge of the next forward facing blades, in turn preventing cuts into the skin bump.

Further, backward facing blades can allow shaving against the first shaving direction S. This may allow cutting hairs from two directions, which may be especially beneficial for users with curly hair in some situations. Curly hair may tend to grow back towards the skin, where it may penetrate the skin, in particular if the hair has a sharp tip. Hair penetrating the skin may lead to skin irritations, in particular pseudofolliculitis barbae. Shaving hairs form two directions may lead to hairs with less sharp tips, compared to hairs only shaved from one direction and therefore the hairs may be less prone to growing back into the skin.

With conventional razor cartridges, it may be necessary to turn the shaving razor assembly at every skin portion that shall be shaved from both directions. The provision of forward and backward facing blades in one cartridge may provide a more efficient shaving procedure, as shaving in two opposite directions can be performed with a single back and forth motion.

The novel razor cartridge according to the first aspect, may further allow providing two forward facing blades with large inter-blade spans. A large inter-blade span may reduce the risk of cutting hairs very close or below the skin level. This may reduce the risk of trapped hairs, which could lead to skin irritation and in particular pseudofolliculitis barbae.

Certain Terms are Used in the Following Manner in the Present Disclosure:

Within the scope of this disclosure, the term “placed between” is not limited to an object being placed directly adjacent to two boundaries (e.g., of objects or elements) but may also encompass the object being placed between two boundaries (e.g., of objects or elements) but not directly adjacent to one or more of the boundaries, but instead directly adjacent to one or more other objects, which are also placed between the two boundaries. In particular within the scope of this disclosure, a first cutting member “placed between” two other cutting members is not bound to the meaning that no further cutting members can be arranged next to the first and one of the further cutting members (i.e., between the first and the one of the further cutting members. The same is true for other components than cutting members (e.g., a housing or guard component can be arranged next to the first cutting member being between two other cutting members).

The expression “first shaving direction” can but does not have to express any preference for the first shaving direction compared to a second (further) shaving direction the cartridges of the present disclosure might provide. The razor cartridges of the present disclosure can have a preferred direction (e.g., including a larger number of “active blades”) in some examples but can also be symmetrical (i.e., the cartridge looks the same when seen from the first and the second shaving direction).

The term “cutting-edge plane” is defined as the plane intersecting first and second skin contact areas of, for example, cutting edges of the shaving head. Movement of the razor handle by the user during shaving operation causes the blades of the razor cartridge to be moved across the cutting-edge plane in the shaving direction, enabling the blades to remove unwanted hair.

In use, in particular if the position of the cutting edges in relation to the razor cartridge is not fixed, the cutting edge plane may not be definable.

The term “shaving plane” SH is defined as the plane between the most prominent members of the housing of a razor cartridge. For example, the shaving plane SH may be defined as the plane between a guard member and a cap member that contact a user, in use. The shaving plane represents the theoretical position of the surface being shaved, which may be the skin. The shaving plane and cutting-edge plane may be congruent, if the cutting edge of the cutting members, lies in the same plane as the shaving plane, e.g. when the cutting edges are in the same plane, as the guard and cap member.

The term “inter-blade span” is herein defined as the span between two adjacent cutting edges,

The term “cutting-edge axis” is herein defined as the bisecting angle of the cutting-edge angle.

The cutting-edge angle is the angle formed by the tapered end of a blade or cutting member intended for cutting hair.

As mentioned before, a “shaving plane SH” is typically defined by the most prominent members of the housing of a razor cartridge. Based on that, an exposure E (of the cutting-edge plane with respect to the shaving plane) can be designated as negative, neutral, or positive. A neutral exposure defines that the cutting-edge plane is substantially coplanar with the shaving plane. A negative exposure implies that the cutting-edge plane is nearer to the base support member of the razor cartridge than the shaving plane or below the shaving plane. A positive exposure implies that the cutting-edge plane is further from the base support member compared to the shaving plane or above the shaving plane.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different Figures indicate like or similar features.

FIG. 1 is a perspective view of a shaving razor assembly.

FIGS. 2a and 2b schematically illustrate side views of a portion of a prior art razor cartridge 20 in use.

FIG. 3 is a schematic side view of a portion of a prior art razor cartridge 20 in use.

FIG. 4 is a schematic side view of a blade arrangement illustrating potential benefits of an increased number of skin contacts points provided by a cutting member facing opposite the first shaving direction S.

FIG. 5 schematically illustrates embodiments of blade arrangements comprising different blade orientations.

FIG. 6 is a perspective partial exploded view of a razor cartridge 20 according to an embodiment.

FIG. 7a is a schematic cutaway side view of a razor cartridge 20 taken from the embodiment of FIG. 6 along axis P-Q.

FIG. 7b is a duplicate of the schematic cutaway side view of the razor cartridge 20 shown in FIG. 7a that has been differently annotated to illustrate the inter-blade spacing.

FIG. 8a is a schematic side view of a blade arrangement comprising a cutting member with a reduced radius of inner curvature with a low cutting-edge.

FIG. 8b is a duplicate side view of a group of a blade arrangement comprising a cutting member with a low cutting-edge angle with a base portion installed at an angle.

FIG. 9a is a schematic of a cutting member comprising an inward blade support.

FIG. 9b is a schematic of a cutting member comprising an outward blade support.

FIG. 9c is a schematic of an integral blade.

### DETAILED DESCRIPTION OF THE PRESENT DISCLOSURE

Hereinafter, a detailed description will be given of the present disclosure. The terms or words used in the description and the claims of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

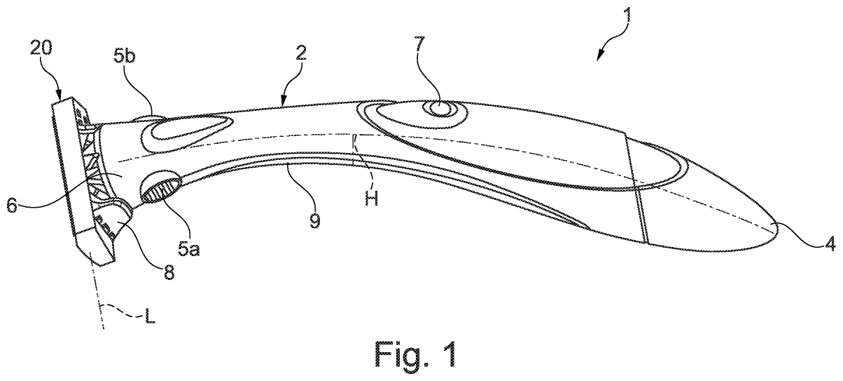

FIG. 1 is a perspective view of a shaving razor assembly 1 according to the present disclosure.

The shaving razor assembly 1 comprises blades. The shaving razor assembly 1 comprises a handle 2 extending in a handle direction H between a proximal portion 4 and a distal portion 6 of the handle 2. A razor cartridge 20 is mounted at the distal portion 6 of the handle 2. The razor cartridge 20 will be presented in more detail following discussion of the shaving razor assembly 1.

The mounting of the razor cartridge 20 to the distal portion 6 of the handle 2 in the illustration is via a pivotable bearing member 8 enabling a frame of reference of the handle 2 to vary relative to a frame of reference of the razor cartridge 20, to thus enable the angle of the razor cartridge 20 against the skin of a user to vary and adapt to changes during use. In particular, the razor cartridge 20 pivots relative to the handle 2 about the longitudinal axis L of the razor cartridge 20, in use. The pivoting enables the user to adapt to contours of the body, for example. The longitudinal axis L of the razor cartridge 20 is substantially perpendicular to the shaving direction along the handle 2. Another example of a connection mechanism for connecting the razor cartridge 20 to the handle 2 is discussed in WO2006/027018 A1. Another alternative is a razor cartridge 20 that may pivot relative to a second pivot axis (a rocking axis), substantially perpendicular to axis L.

In some embodiments, the pivotable bearing member 8 may be omitted (not illustrated) and the handle 2 provided as an integrally connected part of the support of the razor cartridge 20. In some embodiments, the pivotable bearing member 8 may further comprise, or be replaced by, a release mechanism 5a, 5b, enabling rapid release of an exhausted razor cartridge 20 from the handle 2. In some embodiments, the handle 2 and the support of the razor cartridge 20 are integrally formed with a pivotable bearing member (not illustrated) such as a plastic spring member.

A pivotable bearing member (not shown) may, in some embodiments, be provided on the handle side of the razor cartridge 20 configured to connect to a pivotable handle 2. Such a pivotable bearing member, in some embodiments, comprises two or more shell bearings configured to connect to the pivotable bearing member 8 of the handle 2, although a skilled person is familiar with many attachment mechanisms of a razor cartridge 20 to a handle which are not excluded.

In some embodiments, the handle 2 is provided with a handle grip 9 formed of a rubber, or rubber-like material to improve gripping friction. In some embodiments, the handle is provided with a thumb-rest 7 to enable a more secure grip of the handle 2 by a user.

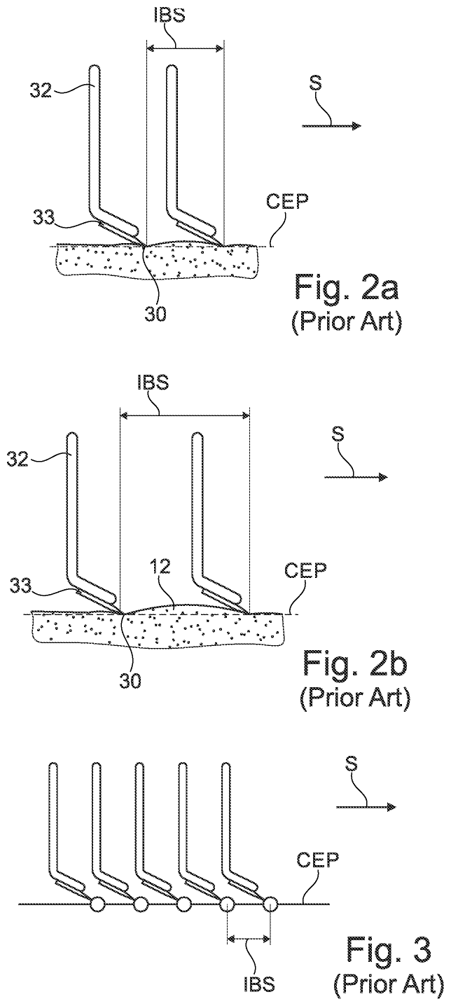

FIG. 2a and FIG. 2b are schematic side views of a portion of a prior art razor cartridge 20 in use.

The shaving direction S is depicted in FIG. 2a using arrow S. The cutting members are drawn across the skin of the user so that the skin is contacted by the cutting-edge plane. A close inter-blade span as schematically illustrated in FIG. 2a may lead to hairs being shaved very close or below the skin surface, which may increase the risk of hairs becoming trapped. Increasing the inter-blade span as schematically illustrated in FIG. 2b may lead to increased bulging, which may lead to an increase in nicks and cuts, in particular if skin bumps are present.

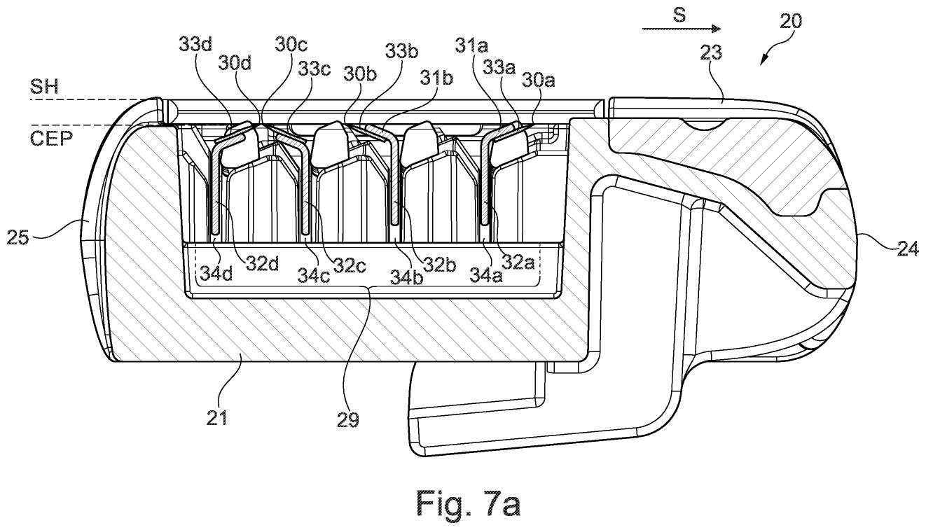

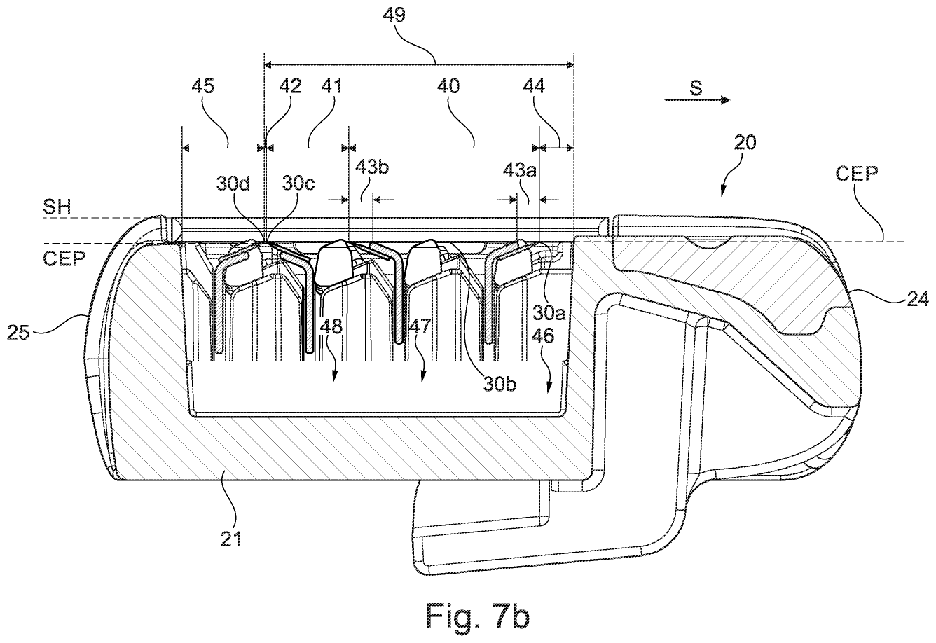

As shown in FIG. 7a, razor cartridges may also comprise a shaving plane. When a conventional razor cartridge 20 is used, shaving may result in nicks and cuts and an increased sense of irritation. This may result from the shaving plane SH (skin) being exclusively supported by the cutting edges 30 of the blades. The cutting edges provide the skin with a relatively small surface to be supported on during shaving. This may cause an increased degree of “bulging” 12 of the shaving plane SH (skin) between the inter-blade spans IBS, which may result in increased irritation during the shaving action.

The razor cartridge 20 comprises a housing 21, wherein the housing comprises a group of cutting members 29 arranged between a trailing longitudinal side 25 and a leading longitudinal side 24 along a first shaving direction (S) (sometimes also referred to abbreviatedly as “shaving direction S” in the present disclosure).

The group of cutting members 29 includes at least two forward facing blades, forward facing blades being characterized by facing in the first shaving direction (S) of the razor cartridge 20. Also, the group of cutting members includes at least one backward facing blade, a backward facing blade being characterized by facing opposite to the shaving direction (S) of the razor cartridge 20.

The at least one backward facing blade, may be placed between the at least two forward facing blades, or the at least one backward facing blade, may be the cutting member closest to the leading longitudinal side 24.

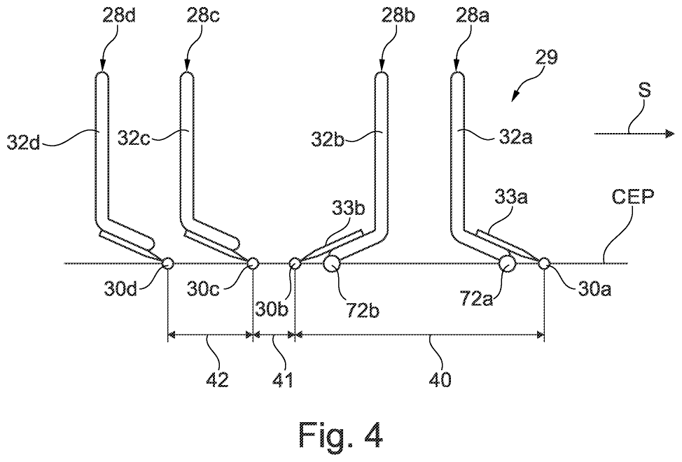

FIG. 3 and FIG. 4 show schematically that a blade edge may act as a “skin contact point” 14. The backward facing blade may provide a skin contact point 14, which may reduce bulging 12 between two forward facing blades.

Alternatively, the “skin contact point” may be considered to be a “skin contact area”. A “skin contact area” means a part of the arrangement of cutting members 28 that comes into contact with the skin of a user of the razor cartridge 20 in normal use. Of course, many parts of the housing 21 and/or guard member 23 will also contact the skin of a user during normal use of the razor cartridge 20, but the term “skin contact area” means the section of a cutting edge 33a-d of one of the blades of the razor cartridge 20. Therefore, when a plurality of cutting members 28a-28d is provided, there will be a plurality of skin contact areas in normal use. It is not essential that every skin contact area functions to cut a hair of the user. In particular, it is not essential that every skin contact area functions to cut a hair of the user in the shaving direction S. The skin contact areas provided by at least one backward facing blade, may provide support to the skin surface, which may reduce bulging 12. The reduction of bulging 12 may reduce skin irritations caused by shaving. Further, the backwards facing blade may guard an adjacent forward facing blade, by guiding the skin away from the blade edge. Further, the placement of at least one backward facing blade between two forward facing blades, may allow a wider inter-blade span between the two forward facing blades. The increased inter-blade span between two forward facing blades may prevent hairs from becoming trapped.

The same principle applies, when shaving opposite the shaving direction using the edge of the backward facing blades, wherein the forward facing blades provide further skin contact points or skin contact areas, which may support the skin to reduce bulging and guide the skin away from the cutting edges.

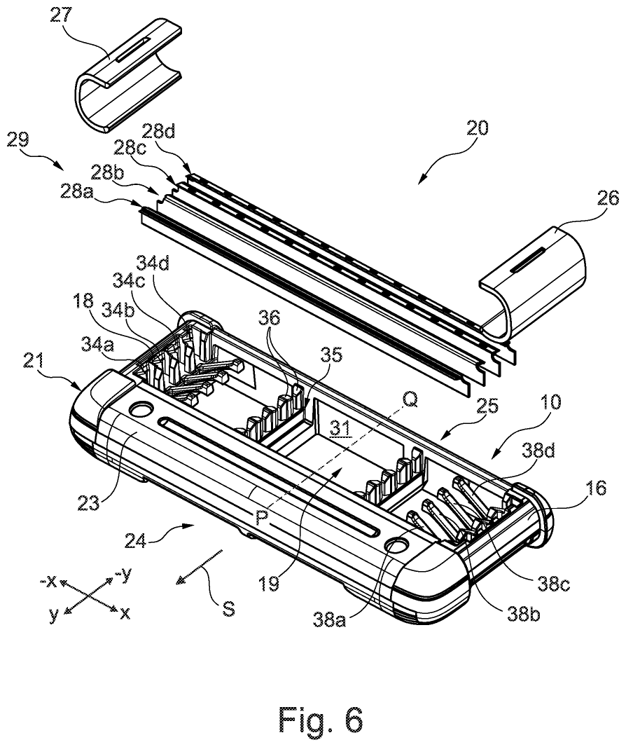

FIG. 6 is a perspective partial exploded view of a razor cartridge 20 according to embodiments of the first aspect. “Partial exploded view” means that some minor components of the razor cartridge 20 have been omitted from the exploded view to aid clarity of the drawing. The razor cartridge 20 comprising the group of cutting members 29. The group of cutting members 29 is accommodated in a blade receiving section 31 of the housing 21. The group of cutting members 29 comprises a plurality of cutting members 28a-d. The cutting members 28a-d may be forward facing blades or backward facing blades. The group of cutting members 29 is disposed in the housing 21 longitudinally and parallel to the shaving plane SH such that in use, blades of the cutting members 28a-d contact the cutting-edge plane CEP and cut hair present on the cutting-edge plane CEP as the razor cartridge 20 is moved across the cutting-edge plane CEP in the shaving direction S.

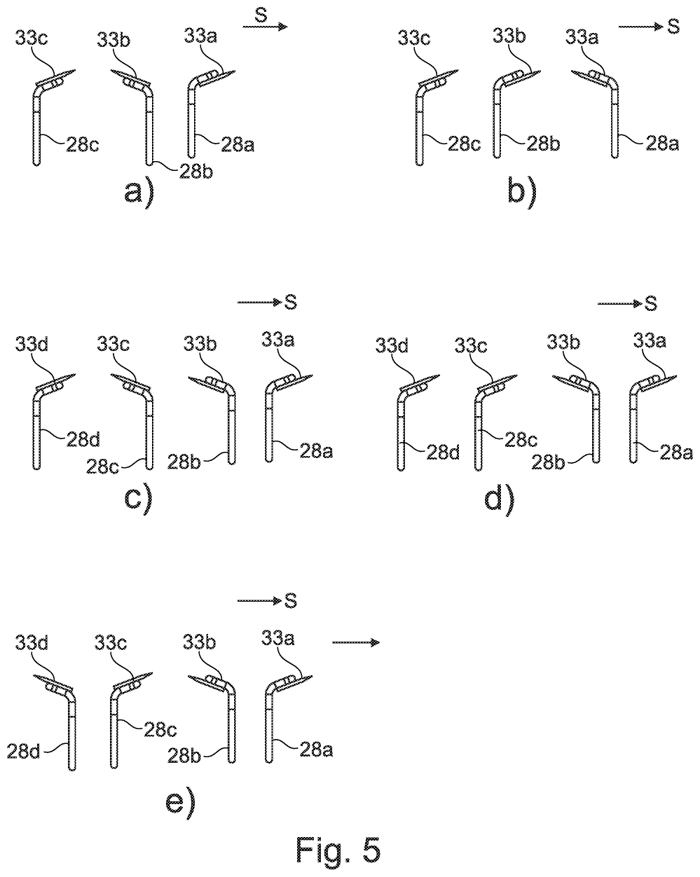

FIG. 5 shows embodiments of blade arrangements comprising forward and backward facing cutting members.

In some embodiments, the group of cutting members 29 may comprise exactly three cutting members, of which two cutting members are forward facing blades and one cutting member may be a backward facing blade.

Razor cartridges comprising three cutting members (e.g., exactly three, or more than three cutting members), wherein one cutting member is a backward facing blades, may allow shaving in both directions. Further, razor cartridges comprising three cutting members may provide the user with an improved feeling of precision, due to the possibly reduced dimensions of the razor cartridges, compared to state of the art razor cartridges comprising groups of cutting members facing in different direction, arranged adjacent to one another.

In some embodiments, the group of cutting members may comprise two forward facing blades and two backward facing blades.

Razor cartridges comprising four members (e.g., exactly four, or more than four cutting members), wherein two cutting members are forward facing blades and two cutting members are backward facing blades, may improve shaving wider areas of skin in both directions, as the shaving properties in both shaving directions may be similar, while in both shaving directions the skin is supported by the additional skin contact areas.

In some embodiments, the group of cutting members may comprise four cutting members, three of which may be forward facing blades and one may be a backward facing blade.

Razor cartridges comprising four cutting members, wherein three cutting members are forward facing blades and one cutting member is a backward facing blade, may improve trimming, as only a single blade facing against the shaving direction may provide the user with a feeling of precision, while providing several shaving contact areas to possibly reduce nicks and cuts.

In some embodiments, at least two backward facing blades may be placed between at least two forward facing blades.

Having introduced the concept of a group of cutting members 29 with a combination of cutting members mounted facing in the first shaving direction S or against the first shaving direction S (i.e., facing a second shaving direction), the mounting of the cutting members in a razor cartridge 20 will now be discussed.

Returning to FIG. 6, the housing 21 comprises first 16 and second 18 side portions. The housing 21 may comprise first retainer 26 and second retainer 27 configured to mate resiliently with the respective first 16 and second 18 side portions to confine the cutting members within the razor cartridge 20 housing 21, although other retaining mechanisms are known to a skilled person and are not excluded. When the razor cartridge 20 is in an assembled state, the first and second side portions 16, 18 are configured to confine the longitudinal ends of the guard member 23, and the cutting members 28a-28d of the group of cutting members 29. The space formed in the assembled stated within the housing 21 by the first 16 and second 18 side portions and the leading longitudinal side 24 and the trailing longitudinal side 25, may be referred to as the recess 19. The first retainer 26 and second retainer 27 may comprise, for example, plastic, an elastomer, a resin, a metal, or metal alloy material and furthermore may be of a different shape to that illustrated.

In some embodiments, the housing 21 may be fabricated partially or completely of synthetic materials, such as plastic, resin, or elastomers. In some embodiments, the housing 21 may be integrally formed. In some embodiments, the housing 21 may be formed from a plurality of sub-assemblies that are joined together by joining methods such as adhesive bonding, interference fitting, or ultrasonic or thermal welding, for example.

The housing 21 comprises a platform member (not shown) connectable to a handle 2 (for example, as shown in FIG. 1) of a shaving razor assembly 1 either integrally, or by a connection mechanism such as a pivotable bearing member 8 or by an interconnecting member (not shown).

In some embodiments, a guard member 23 is provided on the leading longitudinal edge of the razor cartridge 20. In use, the guard member 23 is the first portion of the razor cartridge 20 to contact uncut hairs. The side of the razor cartridge 20 opposite to the leading longitudinal side of the razor cartridge 20 and opposite to the shaving direction is the trailing longitudinal side 25 of the razor cartridge 20. The trailing longitudinal side 25 is thus the final portion of the razor cartridge 20 to contact the shaving plane SH, in use.

It will be noted that the terms “leading longitudinal side 24” and “trailing longitudinal side 25” are used to label specific locations on the razor cartridge 20, and do not imply or require the absence or presence of a particular feature. For example, a guard member 23 may in one example be located at the “leading longitudinal side 24” but it is not essential that this location comprises such a feature.

The guard member 23, in some embodiments, comprises an elastomeric member (not shown in FIG. 6). In some embodiments, the elastomeric layer comprises one or more fins extending longitudinally in parallel to the guard member 23 and substantially perpendicularly to the shaving direction. One purpose of such an elastomeric layer is, for example, to tension the skin prior to cutting.

The razor cartridge 20, as illustrated in FIG. 6, further comprises four resilient fingers 38a, 38b, 38c, 38d provided in the vicinity of the first retainer 26. The razor cartridge 20 comprises four resilient fingers provided in the vicinity of the second retainer 27 that are in transverse corresponding alignment with the four resilient fingers 38a, 38b, 38c, 38d under the first retainer 26. In some embodiments, the resilient fingers 38 are integral with the housing and extend inwardly from the first 16 and second 17 sides.

In total, the eight resilient fingers each exert a bias force against respective cutting members of the group of cutting members 29 in the direction of the cutting-edge plane CEP such that the cutting members of the group of cutting members 29 are in a rest position, when the razor cartridge 20 is assembled. In the rest position, the cutting edges 30 of the blades 33, at each lateral end of the blades 33 near the first 26 and second 27 retainers, bear against corresponding stop portions, for example. In some embodiments, the stop portions may be the first 26 and second 27 retainer.

Accordingly, the rest position of the cutting members 28a-d is well defined, enabling a high shaving precision. Of course, the illustrated biasing arrangement has many variations. For example, a further plurality of resilient fingers may be provided on one or more of the cross members 35. In a simplified razor cartridge 20 design (such as for low cost, disposable razors), the resilient fingers may be omitted. A skilled person will appreciate that the number of resilient fingers 38 to be provided is related to the number of cutting members 28a-d in the group of cutting members 29, and that fewer or more than eight resilient fingers 38 can be provided. It is not essential that the resilient fingers are provided as the skilled person is aware of other mounting means for the cutting members 28. In examples, no biasing members are provided.

In some embodiments, a first debris run-off portion 46, a second debris run-off portion 47, and a third debris run-off portion 48 may be provided. The width of the debris run-off portions is defined by the relative spacing of the cutting members of the plurality of cutting members 29.

Each cutting member in the group of cutting members 29 comprises a longitudinal blade support 32 or a base portion 80. A longitudinal blade is mounted on the blade support 32 or alternatively, formed integrally with the base portion 80. The cutting edge 30 of a cutting member 28a-d may be oriented forward in the direction of shaving S or oriented backward against the direction of shaving S.

Each cutting member in the group of cutting members 29 is, in some embodiments, resiliently mounted in a blade receiving section 31 of the razor cartridge 20. The blade receiving section 31 comprises a longitudinal space in the razor cartridge 20 that is sized to accommodate the group of cutting members 29. At least one cutting member of the group of cutting members 29, up to all cutting members in the group of cutting members 29 may be resiliently mounted on the resilient fingers 38 in the blade housing 21. In the illustrated example of FIG. 6, the transverse inner sides of housing 21 comprise a plurality of holding slots 34. Each holding slot 34 on the transverse inner sides is configured to accept and retain one side of a blade support 32 or a base portion 80 of a cutting member of the group of cutting members 29 so that the cutting members of the group of cutting members 29 are held in the blade receiving section 31. Therefore, as many holding slots 34 are provided in each transverse inner side of housing 21 as there are blade support members.

Between the blade receiving section 31 and the handle (in a part adjacent to a handle 2 connection, for example) there are, in examples, provided one or more cross members 35 that are integrally formed with the housing 21. The cross members 35 may comprise a plurality of blade support guides 36 provided as a plurality of protuberances aligned with the holding slot 34 on the transverse inner sides of the housing 21. The blade support guides 36 function to provide an additional support to the blades in a direction parallel and perpendicular to the longitudinal direction, thus increasing the stability during use.

In the following, the relation between mounting of the blades and ensuing inter-blade spans shall be briefly described. FIG. 7a is a schematic cutaway side view of a razor cartridge 20 taken from the embodiment of FIG. 6 along transverse axis P-Q illustrated by the dotted line in FIG. 6. Where possible, like elements are denoted with like reference numerals.

FIG. 7a illustrates a side view of the holding slots 34a-d provided razor cartridge 20 for holding the cutting members 28a-d of the group of cutting members 29. The plurality of blade support guides 36 and the plurality of resilient fingers 38 shown in FIG. 6 is not shown in the projection of FIG. 7a to aid clarity.

Of course, the provision of a succession of holding slots 34 in the first 26 and second 27 retainers to support the cutting members of the group of cutting members 29 is not essential. The group of cutting members 29 could also be supported using a plurality of blade support guides 36 (protuberances) positioned on one or more cross members 35. In some embodiments, a plurality of blade support guides 36 and a succession of holding slots 34 may be used in combination to provide adjusted inter-blade spaces in the longitudinal direction, to incorporate backward facing blades.

FIG. 7b is a duplicate of the schematic cutaway side view of the razor cartridge 20 shown in FIG. 7a that has been annotated to denote inter-blade spacing. The group of cutting members 29 defines a plurality of substantially parallel inter-blade spans. The number of inter-blade spans is one fewer than the number of cutting members 28a-d.

FIG. 7a further illustrates the cutting members 28a and 28d facing in the shaving direction and the blades 28b and 28c facing opposite the shaving direction. To allow the insertion of backward facing blades into the razor cartridge 20 and to adjust the inter-blade span, in some embodiments, it may be preferable to alter the spacing of the blade supports or integral blades 32 between the leading longitudinal side 24 and the trailing longitudinal side 25 of the razor cartridge 20. One way to alter the spacing of the blade supports 32 or base portions 80, may be to alter the spacing between the holding slots 34 provided on the transverse inner sides in a transverse direction (y to −y) of the razor cartridge 20. The positioning and/or width of the blade support guides 36 is adjusted commensurately, such that space between the cutting edges 30 of the cutting members 28a-d is parallel.

The span 49 between the tip of a trailing blade, wherein the trailing blade is comprised within a forward facing blade, and the edge of the leading longitudinal side facing towards said trailing blade, will be dependent on the number of cutting members 28 incorporated into the razor cartridge 20.

In some embodiments, the span between the tip of a forward facing blade and the tip of another forward facing blade, wherein exactly one backward facing blade is placed between the two forward facing blades, may be at least 1.5 mm, more specifically at least 2.0 mm and in particular at least 2.3 mm.

The inter-blade span between the tip of a forward facing blade and the tip of the next backward facing blade in shaving direction, may be between about 0.70 mm to about 1.1 mm, more specifically about 0.80 mm to about 1.0 mm and in particular about 0.85 mm to about 0.95 mm. The inter-blade span between the tip of a forward facing blade and the tip of the next backward facing blade in shaving direction, may be between about 0.45 mm to about 0.80 mm, more specifically about 0.55 mm to about 0.70 mm and in particular about 0.60 mm to about 0.65 mm. In some embodiments, the inter-blade span between the tip of a forward facing blade and the tip of the next backward facing blade in shaving direction, may be between about 0.20 mm to about 0.60 mm, more specifically about 0.30 mm to about 0.50 mm and in particular about 0.35 mm to about 0.45 mm.

Any of the aforementioned spans may be a leading inter-blade span 40, a first intermediate inter-blade span 41 or a trailing inter-blade span 42, as long as it is a span between the tip of forward facing blade and the tip of the next backward facing blade in shaving direction. The terms trailing inter-blade span or trailing blade refer to an inter-blade span or blade, which is closest to the trailing longitudinal side. Analogously, the terms leading inter-blade span or leading blade refer to an inter-blade span or blade, which is closest to the leading longitudinal side. The term intermediate inter-blade span refers to inter-blade spans, which are positioned between a leading and a trailing inter-blade span.

The span between the tip of the rearmost forward facing blade in shaving direction and the edge of the leading longitudinal side facing towards said forward facing blade, is between about 0.50 mm to about 0.90 mm, more specifically about 0.60 mm to about 0.80 mm and in particular about 0.65 mm to about 0.70 mm. In other words, in some embodiments, the leading blade to frame span 44 between the tip of the leading blade, wherein the leading blade is comprised within a forward facing blade, and the edge of the leading longitudinal side facing towards said forward facing blade, may be between about 0.50 mm to about 0.90 mm, more specifically about 0.60 mm to about 0.80 mm and in particular about 0.65 mm to about 0.70 mm.

The leading blade to frame span 45 between the tip of the trailing blade, wherein the trailing blade is comprised within a backward facing blade, and the edge of the trailing longitudinal side facing towards said backward facing blade, may be between about 0.50 mm to about 0.90 mm, more specifically about 0.60 mm to about 0.80 mm and in particular about 0.65 mm to about 0.70 mm.

The span between the tip of the foremost forward facing blade in shaving direction and the edge of the leading longitudinal side facing towards said forward facing blade, may be between about 4.0 mm to about 6.0 mm, more specifically about 4.5 mm to about 5.5 mm and in particular about 5.1 mm to about 5.3 mm.

In other words, the span 49 between the tip of a trailing blade, wherein the trailing blade is comprised within a forward facing blade, and the edge of the leading longitudinal side facing towards said trailing blade, may be between about 4.0 mm to about 6.0 mm, more specifically about 4.5 mm to about 5.5 mm and in particular about 5.1 mm to about 5.3 mm, in particular in a razor cartridge comprising three cutting members.

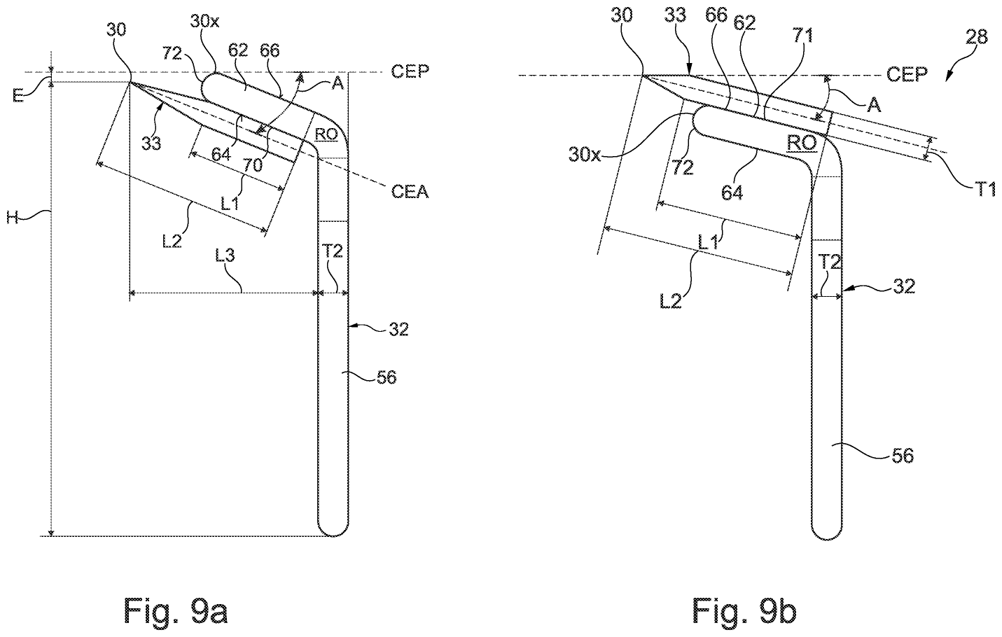

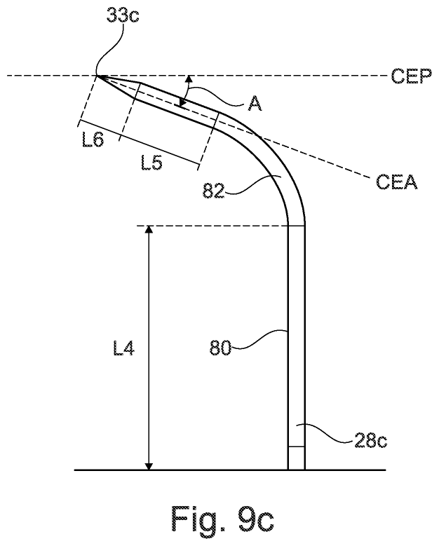

In the following, the design of the cutting members shall be discussed. The particular design of the cutting members 28 is not particularly limited. FIG. 9a, FIG. 9b and FIG. 9c show different types of cutting members, which may be used as forward facing blades or backward facing blades.

FIG. 9a is a schematic side view of a cutting member 28 comprising a blade mounting portion 70 disposed on an inward blade support that, in use, faces away from a shaving plane SH.

FIG. 9b is a schematic side view of a cutting member 28 comprising a blade mounting portion 71 disposed on an outward blade support that, in use, faces towards a shaving plane SH.

The inward and outward blade support may have analogue structures, except for the blade mounting portions 70 and 71 being placed on opposing sides. In the following, the cutting members comprising a blade mounting portion, are described in more detail.

A blade support member (in other words a cutting member 28 without the blade 33 attached) comprises a substantially elongated flat lower portion 56, a substantially elongated flat top side 62, and a radius bend portion 58. The radius bend portion 58 may have an inner radius of curvature RO that is more than 0.1 mm. The radius bend portion 58 may have an inner radius of curvature RO that is less than 0.9 mm. A minimum recommended inner radius of curvature RO of sheet metal should be at least the same as its thickness T2. A safety factor of the thickness of the blade support 32 may be applied. By multiplying the safety factor with the thickness of T2 (around 0.17 mm), the radius of curvature RO may be approximately 0.25 mm, more specifically between 0.16 mm and 0.40 mm, and most specifically between 0.25 mm or 0.28 mm.

Alternatively, instead of a radius bend portion 58, the blade support member may have a groove (e.g., a V-shaped groove) along the length of the bend portion. The (V-shaped) groove may be applied by pre-scoring.

The blade support 32 may have a rounded or chamfered front end 72, to improve the glide properties of the cutting member. There may be a span 43 between the front end of the blade support and the cutting edge of the blade.

The blade support 32 may be made from a flat sheet metal part which is formed into a curvilinear section. In some embodiments, the blade support 32 is made from a metal such as austenitic stainless steel. After forming the curvilinear section, for cutting members wherein the blade is attached to an inward blade mounting portion, welding of the blade 33 on an inner surface 64 of the blade support 32 is performed. The cutting member 28 thus comprises a blade 33 (razor blade). Analogously, cutting members wherein the blade is attached to an outward blade mounting portion, welding of the blade 33 on an outer surface 66 of the blade support 32 is performed.

The blade 33 has, in its flat portion, a thickness T1 about 0.1 mm (for example, between 0.04 and 0.11 mm). The total length L2 of the blade 33 between the cutting edge 30 of the blade 33 and the opposite back edge of the blade 33 is about 1 mm (for example, between 0.8 mm and 1.3 mm). The portion of the blade 33 that is in contact with the inner surface 64 of a blade support that, in use, faces away from a shaving plane SH has a length L1 that is about 0.49 mm+/−0.1 mm long. In this way, a good retention of the blade on the underside of the blade support 32 (the inner surface of the blade support 32) is ensured.

In some embodiments at least one of the cutting members of the group of cutting members, may comprise an inward blade support having an inward blade mounting portion 70 disposed on an inner surface of the inward blade support that, in use, faces away from a shaving plane SH, and a first blade 33 attached to the inward blade mounting portion 70 and may be referred to as an inward blade in the following.

An inward blade may comprise an exposure between the upper edge of the inward blade support 30x and the cutting edge 33, as shown in FIG. 9a. In some embodiments, an inward blade may have an exposure E relative to the cutting-edge plane CEP in the range 0 um to −80 um, more specifically an exposure of about −75 um, −65 um, −60 um, −55 um, −50 um, −45 um, −40 um, −35 um, −30 um, −25 um, −20 um, −15 um, −10 um, −5 um, 0 um.

In some embodiments, at least one of the cutting members of the group of cutting members may comprise an outward blade support having an outward blade mounting portion 71 disposed on an outward surface of the outward blade support that, in use, faces towards a shaving plane, and an outward blade 33 attached to the outward blade mounting portion 71 and will be referred to as an outward blade in the following.

FIG. 9c is a schematic side view of an integrally formed cutting member 28c, also referred to as integral blade, having performed at its distal end a blade 33c. The integrally formed cutting member 28c comprises a base portion 80 having a height L4, a curvilinear portion 82, and a cutting-edge portion that is substantially linear and that forms an acute angle A with the cutting-edge plane CEP. The cutting-edge portion may be divided into a section having a parallel portion of length L5, and a portion that narrows towards the cutting edge 33e of length L6. The material examples and dimensions discussed in relation to the cutting member illustrated in FIG. 9a and FIG. 9b may also be used to provide the integrally formed cutting member 28c. In some embodiments, at least one of the cutting members of the group of cutting members, may comprise an integral blade, in particular as a backward facing blade.

In some embodiments at least one of the cutting members of the group of cutting members, may further comprise a skin-guard element.

The skin-guard element may be in particular a comb-like structure. The comb-like structure may provide a further skin contact area. Further, the comb-like structure may raise the hair before cutting, hereby approaching a right angle between the cutting-edge axis of the cutting edge and the hair. This may allow cutting hair with a duller tip, as compared to cutting the hair without a comb-like structure.

The comb-like structure may be a separate element attached to a blade support, in particular a separate element which protrudes into the shaving plane (SH). In some embodiments, the comb-like structure may be an integrative element of an outward blade support. The comb-like structure may be an integrative element of an inward blade support.

In some embodiments, one or more of the cutting members, may be spring-loaded, in particular one or more cutting members may be spring loaded by one or more springs (not illustrated) placed in the holding slot. Alternatively, or additionally one or more springs may be placed on one or more blade support guides 36. The one or more spring-loaded cutting member may be configured to move in the direction perpendicular to the shaving plane. This may in particular allow the cutting members to retract into the razor cartridge, away from the shaving plane, thus gaining negative exposure.

FIG. 6 illustrates the y- and x-axis of the razor cartridge. The retraction of a cutting member into the razor cartridge, away from the shaving plane, may not occur uniform along the width of the cutting member, but instead the cutting member may tilt around the y-axis. The width of the cutting member is the dimension of the cutting member along the x-axis. Due to the tilting, the exposure of the cutting edge may differ along the width of the cutting edge member. As different cutting members may tilt in varying degrees and/or directions, the cutting edges may not be coplanar, and therefore, the cutting edges may not define a cutting edge plane CEP during use.

In some embodiments, one or more spring-loaded cutting members may be forward facing blades.

In use, the perpendicular movement of the spring-loaded forward facing blades, may reduce the pressure between the blade edges and the skin. Reduced pressure between the blade edges and the skin may lead to less skin irritation caused by shaving.

In some embodiments at least one backward facing blade may not be spring-loaded.

In particular, when one or more spring-loaded forward facing blades is combined with one or more non-spring-loaded backward facing blades, the pressure between the skin and blade edges of the forward facing blades may be reduced, as the backward facing blades may support the skin.

When shaving in the direction opposite the first shaving direction S, utilizing the one or more backward facing blades, the backward facing blade(s) being fixed in the housing, may allow the backward facing blade(s) to shave hairs closer to the skin. Shaving hairs closer to the skin with a backward facing blade may be advantageous when cutting hairs which have already been cut a first time with a forward facing blade. Herein, the remaining hair stubble may be cut more precisely, as compared to a less close shave, which may allow dulling the edge of more hair stubbles. Shaving hairs closer to the skin with a backward facing blade, may also be advantageous in trimming as skin irritation may not be a prominent factor, as trimming may be applied to smaller skin areas.

In some embodiments, the cutting member 28 may be spring-loaded to have a maximum exposure E relative to the cutting-edge plane CEP in the range 0 um to −800 um, more specifically an exposure of about −750 um, −650 um, −600 um, −550 um, −500 um, −450 um, −400 um, −350 um, −300 um, −250 um, −200 um, −150 um, −100 um, −50 um, −25 um, −10 um, −5 um.

The type of spring is not particularly limited, but may comprise compression springs, torsion springs, flat springs, torsion bars and in particular cup springs. The material of the spring is not particularly limited, but may comprise metals, polymers, or elastomers. In particular, springs manufactured from elastomers, may comprise any geometry, as long as the spring can exert a restoring force on one or more cutting members.

The spring rate may vary between individual cutting members. Further, in some embodiments, one or more cutting members may have a positive exposure. In particular, one or more spring-loaded cutting members may have a positive exposure in the rest position, wherein the rest position, is the position of a cutting member, when the cutting member is not subjected to forces other than those stemming from the biasing arrangement.

Turning briefly to FIG. 9a, FIG. 9b and FIG. 9c, the shaving angle A defines the angle of declination of the cutting-edge axis CEA and the CEP or the shaving plane.

In some embodiments, the angle A between the cutting-edge axis CEA of at least one blade and the cutting-edge plane, may be between about 10° to about 35°, more specifically about 15° to about 30° and in particular about 20° to about 25°.

In some embodiments, the angle A between the cutting-edge axis CEA of at least one blade and the cutting-edge plane, may be between about 5° to about 30°, more specifically about 10° to about 25° and in particular about 12° to about 17°.

In some embodiments, the angle A between the cutting-edge axis CEA of at least one blade, in particular the backward facing blade, and the cutting-edge plane, may be between about −10° to about 15°, more specifically about −5° to about 10° and in particular about 0° to about 5°.

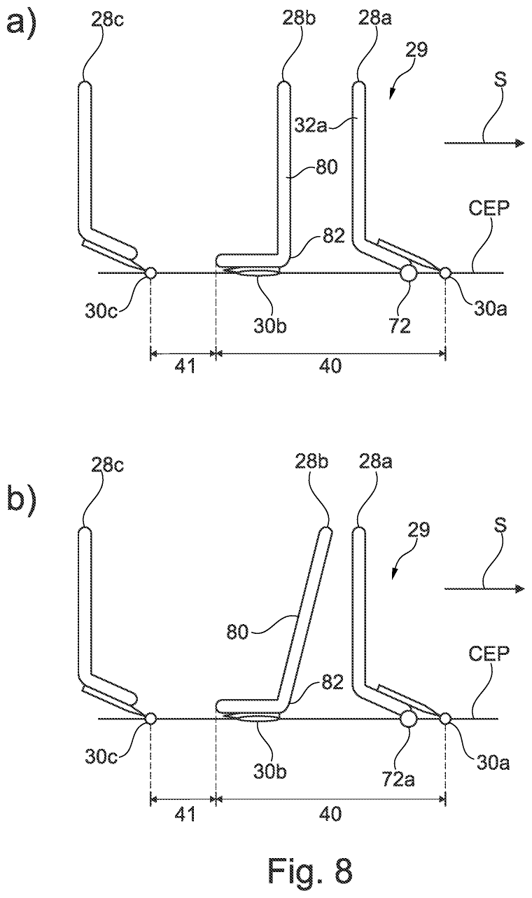

In some embodiments, in particular a backward facing blade with a low cutting-edge axis CEA angle may be preferable, as users may try to remove shaving debris by wiping the razor cartridge 20 in the shaving direction with a finger. Herein, injury to the user's finger may be prevented by providing a backward facing blade with a low cutting-edge axis CEA angle, as it may not penetrate into the skin. Further, as shown in FIG. 8a and FIG. 8b a blade, at a low angle, may provide an especially wide skin contact area.

In some embodiments, the razor cartridge may comprise three cutting members, wherein the backwards facing blade comprises a low cutting-edge axis, in particular a cutting-edge axis of 0°.

The altered cutting-edge axis CEA may be provided by two possible means. One possible means may be to reduce the inner radius of curvature. A second possible means may be to install the lower portion of the blade support 56 or the base portion 80 at an angle within the cartridge. Other elements, such as the blade support guide 36 or the resilient fingers 38, may need to be adjusted accordingly.

In some embodiments, the razor cartridge 20 may comprise an additional trimming member (not illustrated) on the trailing longitudinal side.

In some embodiments, the cutting-edge axis CEA of the trimming member may be substantially perpendicular to the shaving plane.

In some embodiments, the shaving razor assembly may further comprise a motor.

FIG. 5a schematically illustrates an embodiment, wherein the first 28a and third 28c cutting members seen from the leading longitudinal side are forward facing blades and the second cutting member 28b is a backward facing blade. Further, in the illustrated embodiment the second 28b and third 28c cutting members seen from the leading longitudinal side are outward blades, and the first 28a cutting member is an inward blade.

FIG. 5b schematically illustrates an embodiment, wherein the second 28b and third cutting members 28c seen from the leading longitudinal side are forward facing blades and the first cutting member 28a is a backward facing blade. Further, in the illustrated embodiment the first 28a and second 28b cutting members seen from the leading longitudinal side are inward blades, and the first cutting member 28a is an inward blade.

FIG. 5c schematically illustrates an embodiment, wherein the second 28b and third 28c cutting members seen from the leading longitudinal side are forward facing blades and the first 28a and fourth 28d cutting members are backward facing blades. Further, in the illustrated embodiment the second 28b, third 28c and fourth 28d cutting members seen from the leading longitudinal side are inward blades, and the first 28a cutting member is an outward blade.

FIG. 5d schematically illustrates an embodiment, wherein the first 28a, third 28c and fourth 28d cutting members seen from the leading longitudinal side are forward facing blades and the second 28b cutting member is a backward facing blade. Further, in the illustrated embodiment the first 28a and second 28b cutting members seen from the leading longitudinal side are inward blades, and the third 28c and fourth 28d cutting member are outward blades.

FIG. 5e schematically illustrates an embodiment, wherein the first 28a and third 28c cutting members seen from the leading longitudinal side may be forward facing blades and the second 28b and fourth 28b cutting members are backward facing blades. Further, in the illustrated embodiment the first 28a, second 28b and third 28c cutting members seen from the leading longitudinal side are inward blades, and the fourth 28d cutting member is an outward blade.

In some embodiments, the third 28c and fourth 28d cutting members seen from the leading longitudinal side may be forward facing blades and the first 28a and second cutting members 28b may be backward facing blades.

In some embodiments, the first 28a and second 28b cutting members seen from the leading longitudinal side may be forward facing blades and the third 28c and fourth 28d cutting members may be backward facing blades.

In some embodiments, the first 28a and fourth 28d cutting members seen from the leading longitudinal side may be forward facing blades and the second 28b and third 28c cutting members may be backward facing blades.

In some embodiments, the first 28a, and third 28c cutting members may be forward facing blades and the second 28b and fourth 28d cutting members may be backward facing blades.

In some embodiments the second 28b, and fourth 28d cutting members may be forward facing blades and the first 28a and third 28c cutting members may be backward facing blades.

In some embodiments, the first 28a, second 28b, and fourth 28d cutting members may be forward facing blades and the third cutting member seen from the leading longitudinal side may be a backward facing blade.

In some embodiments, the razor cartridge 20 may comprise five cutting members, wherein one cutting member is a backward facing blade.

In some embodiments, the razor cartridge 20 may comprise five cutting members, wherein two cutting members are backward facing blades.

In some embodiments, the razor cartridge 20 may comprise five cutting members, wherein three cutting members are backward facing blades.

In some embodiments, the razor cartridge may comprise three cutting members, the group of cutting members comprising at least one integral blade, one outward blade and one inward blade.

FIG. 8a and FIG. 8b schematically illustrate an embodiment, wherein the first cutting member 28a is an inward blade and forward facing blade, the second cutting member 28b is an integral blade and backward facing blade and the third cutting member is an outward blade and forward facing blade.

In some embodiments, the razor cartridge may comprise three cutting members, wherein at least one cutting member comprises a comb-like structure, in particular a backward facing blade may comprise a comb-like structure. In some embodiments, the razor cartridge may comprise four cutting members, wherein at least one cutting member comprises a comb-like structure, in particular two backward facing blades may comprise a comb-like structure. In some embodiments, the razor cartridge may comprise four cutting members, wherein at least one cutting member comprises a comb-like structure, in particular a forward facing blade may comprise a comb-like structure.

In some embodiments, a razor cartridge may comprise two forward facing blades and one backward facing blade may be provided, wherein the two forward facing blades are spring-loaded.

In some embodiments, a razor cartridge may comprise two forward facing blades and one backward facing blade may be provided, wherein the one forward facing blade is spring-loaded.

In some embodiments, a razor cartridge comprising three forward facing blades and one backward facing blade may be provided, wherein the three forward facing blades are spring-loaded.

In some embodiments, a razor cartridge may comprise four cutting members, wherein one cutting member is spring-loaded. In some embodiments, a razor cartridge may comprise four cutting members, wherein two cutting members are spring-loaded. In some embodiments, a razor cartridge may comprise four cutting members, wherein three cutting members are spring-loaded. In some embodiments, one or more of the backward facing members may be spring-loaded.

According to a second aspect, there may be provided a shaving razor assembly comprising a razor handle and a razor cartridge 20, wherein the razor cartridge 20 is either releasably attached to the razor handle 2 via a pivotable or non-pivotable connection, integrally formed with the razor handle 2 via a non-pivotable connection, or integrally formed with the razor handle 2 via a pivotable connection.

According to a third aspect, there may be provided a kit of parts comprising a razor handle and a razor cartridge holder comprising a plurality of razor cartridges 20.

The present disclosure also relates to the cutting members, razor cartridges, razors, kits, and methods of the following aspects:
1. A razor cartridge comprising:
   a housing, wherein the housing comprises a group of cutting members arranged between a trailing longitudinal side and a leading longitudinal side along a first shaving direction (S); and
   wherein the group of cutting members includes at least two forward facing blades, forward facing blades being characterized by facing in the first shaving direction (S) of the razor cartridge; and,
   wherein the group of cutting members includes at least one backward facing blade, a backward facing blade being characterized by facing opposite to the first shaving direction (S) of the razor cartridge; and,
   wherein the at least one backward facing blade, is placed between the at least two forward facing blades,
   or wherein the at least one backward facing blade, is the cutting member closest to the leading longitudinal side.
2. A razor cartridge according to aspect 1, wherein the group of cutting members comprises exactly three cutting members, of which two cutting members are forward facing blades and one cutting member is a backward facing blade.
3. A razor cartridge according to aspect 2, wherein the second and third cutting members seen from the leading longitudinal side are forward facing blades and the first cutting member is a backward facing blade.
4. A razor cartridge according to aspect 2, wherein the first and third cutting members seen from the leading longitudinal side are forward facing blades and the second cutting member is a backward facing blade.
5. A razor cartridge according to aspect 1, wherein the group of cutting members comprises two forward facing blades and two backward facing blades.
6. A razor cartridge according to aspect 5, wherein the second and third cutting members seen from the leading longitudinal side are forward facing blades and the first and fourth cutting members are backward facing blades.
7. A razor cartridge according to aspect 5, wherein the third and fourth cutting members seen from the leading longitudinal side are forward facing blades and the first and second cutting members are backward facing blades.
8. A razor cartridge according to aspect 5, wherein the first and second cutting members seen from the leading longitudinal side are forward facing blades and the third and fourth cutting members are backward facing blades.
9. A razor cartridge according to aspect 5, wherein the first and fourth cutting members seen from the leading longitudinal side are forward facing blades and the second and third cutting members are backward facing blades.
10. A razor cartridge according to aspect 5, wherein the first, and third cutting members are forward facing blades and the second and fourth cutting members are backward facing blades.
11. A razor cartridge according to aspect 5, wherein the second, and fourth cutting members are forward facing blades and the first and third cutting members are backward facing blades.
12. A razor cartridge according to aspect 1, wherein the group of cutting members comprises four cutting members, of which three are forward facing blades and one is a backward facing blade.
13. A razor cartridge according to aspect 12, wherein the first, third and fourth cutting members seen from the leading longitudinal side are forward facing blades and the second cutting member is a backward facing blade.
14. A razor cartridge according to aspect 12, wherein the first, second, and fourth cutting members are forward facing blades and the third cutting member seen from the leading longitudinal side is a backward facing blade.
15. A razor cartridge according to aspect 5, wherein at least two backward facing blades are placed between the at least two forward facing blades.
16. A razor cartridge according to aspect 1, wherein the razor cartridge comprises five cutting members.
17. A razor cartridge according to any preceding aspect, wherein at least one of the cutting members of the group of cutting members, comprises an inward blade support having an inward blade mounting portion disposed on an inner surface of the inward blade support that, in use, faces away from a shaving plane, and an inward blade attached to the inward blade mounting portion.
18. A razor cartridge according to any preceding aspect, wherein at least one of the cutting members of the group of cutting members comprises an outward blade support having an outward blade mounting portion disposed on an outward surface of the outward blade support that, in use, faces towards a shaving plane, and an outward blade attached to the outward blade mounting portion.
19. A razor cartridge according to any preceding aspect, wherein at least one of the cutting members of the group of cutting members, comprises an integral blade, in particular as a backward facing blade.
20. A razor cartridge according to any preceding aspect,
   wherein at least one of the cutting members of the group of cutting members, further comprises a skin-guard element, in particular a skin guard element including a comb-like structure, in particular as a backward facing blade.
21. A razor cartridge according to aspect 20,
   wherein the comb-like structure, is a separate element attached to a blade support, in particular a separate element which protrudes into the shaving plane (SH).
22. A razor cartridge according to aspect 20,
   wherein the comb-like structure is an integrative element of an outward blade support.
23. A razor cartridge according to aspect 20,
   wherein the comb-like structure is an integrative element of an inward blade support.
24. A razor cartridge according to any preceding aspect,
   wherein the span between the tip of forward facing blade and the tip of the next backward facing blade in the first shaving direction, is between about 0.70 mm to about 1.1 mm, more specifically about 0.80 mm to about 1.0 mm and in particular about 0.85 mm to about 0.95 mm.
25. A razor cartridge according to any preceding aspect,
   wherein the span between the tip of forward facing blade and the tip of the next backward facing blade in the first shaving direction, is between about 0.45 mm to about 0.80 mm, more specifically about 0.55 mm to about 0.70 mm and in particular about 0.60 mm to about 0.65 mm.
26. A razor cartridge according to any preceding aspect,
   wherein the span between the tip of forward facing blade and the tip of the next backward facing blade in the first shaving direction, is between about 0.20 mm to about 0.60 mm, more specifically about 0.30 mm to about 0.50 mm and in particular about 0.35 mm to about 0.45 mm.
27. A razor cartridge according to any preceding aspect,
   wherein the span between the tip of the rearmost forward facing blade in the first shaving direction and the edge of the leading longitudinal side facing towards said forward facing blade, is between about 0.50 mm to about 0.90 mm, more specifically about 0.60 mm to about 0.80 mm and in particular about 0.65 mm to about 0.70 mm.
28. A razor cartridge according to aspect 1 or 2,
   wherein the span between the tip of the foremost forward facing blade in the first shaving direction and the edge of the leading longitudinal side facing towards said forward facing blade, is between about 4.0 mm to about 6.0 mm, more specifically about 4.5 mm to about 5.5 mm and in particular about 5.1 mm to about 5.3 mm.
29. A razor cartridge according to any preceding aspect,
   wherein the angle between the cutting-edge axis of at least one blade and the cutting edge plane, is between about 10° to about 35°, more specifically about 15° to about 30° and in particular about 20° to about 25°.
30. A razor cartridge according to any preceding aspect,
   wherein the angle between the cutting-edge axis of at least one blade and the cutting edge plane, is between about 5° to about 30°, more specifically about 10° to about 25° and in particular about 12° to about 17°.
31. A razor cartridge according to any preceding aspect,
   wherein the angle between the cutting-edge axis of at least one blade, in particular the backward facing blade, and the cutting edge plane, is between about −10° to about 15°, more specifically about −5° to about 10° and in particular about 0° to about 5°.
32. A razor cartridge according to any preceding aspect,
   wherein the razor cartridge comprises a trimming member on the trailing longitudinal side.
33. A razor cartridge according to aspect 32,
   wherein the cutting-edge axis of the trimming member is substantially perpendicular to the shaving plane.
34. A shaving razor assembly comprising:
   a razor handle;
   a razor cartridge according to any preceding aspect, wherein the razor cartridge is either releasably attached to the razor handle via a pivotable or non-pivotable connection, integrally formed with the razor handle via a non-pivotable connection, or integrally formed with the razor handle via a pivotable connection.
35. A kit of parts comprising:
   a razor handle; and
   a razor cartridge holder comprising a plurality of razor cartridges according to any preceding aspect.
36. A shaving razor assembly according to aspect 34, wherein the shaving razor assembly further comprises a motor.
37. A razor cartridge according to any preceding aspect, wherein at least one backward facing blade is not spring-loaded.

In the preceding specification, numerous specific details are set forth in order to provide a thorough understanding. It will be apparent, however, to one having ordinary skill in the art that the specific detail need not be employed to practice the present disclosure. In other instances, well-known materials or methods have not been described in detail in order to avoid obscuring the present disclosure.

Reference throughout the preceding specification to “one embodiment”, “an embodiment”, “one example” or “an example”, “one aspect” or “an aspect” means that a particular feature, structure, or characteristic described in connection with the embodiment or example is included in at least one embodiment of the present disclosure. Thus, appearances of the phrases “in one embodiment”, “in an embodiment”, “one example” or “an example”, “one aspect” or “an aspect” in various places throughout this specification are not necessarily all referring to the same embodiment or example.

Furthermore, the particular features, structures, or characteristics may be combined in any suitable combinations and/or sub-combinations in one or more embodiments or examples.

REFERENCE NUMERALS

| E | Exposure |
|---|---|
| S | First shaving direction |
| SH | Shaving plane |
| CEP | cutting-edge plane |
| CEA | cutting-edge axis |
| H | Handle direction |
| L | Longitudinal direction |
| IBS | inter-blade span |
| RO | inner radius of curvature |
| T1 | Razor blade thickness |
| T2 | Blade support thickness |
| P-Q | transverse axis |
| 1 | Shaving razor assembly |
| 2 | Handle |
| 4 | proximal portions |
| 5a, 5b | release mechanism |
| 6 | distal portion |
| 7 | thumb rest |
| 8 | pivotable bearing member |
| 9 | handle grips |
| 12 | bulging |
| 14 | skin contact point |
| 16 | first side portion |
| 18 | second side portion |
| 19 | recess |
| 20 | razor cartridge |
| 21 | housing |
| 23 | guard member |
| 24 | leading longitudinal side |
| 25 | trailing longitudinal side |
| 26 | first retainer |
| 27 | second retainer |
| 28a-d | cutting member |
| 29 | group of cutting members |
| 30a-d | cutting edge |
| 31a-d | blade receiving section |
| 32 | blade support |
| 33a-d | blade |
| 34a-d | holding slots |
| 35 | cross member |
| 36 | blade support guide |
| 38a-d | resilient finger |
| 40 | leading inter-blade span |
| 41 | intermediate inter-blade span |
| 42 | trailing inter-blade span |
| 43a-d | cutting edge to blade span |
| 44 | leading blade to frame span |
| 45 | trailing blade to frame span against the |
| | shaving direction |
| 46 | first debris run-off portion |
| 47 | second debris run-off portion |
| 48 | third debris run-off portion |
| 49 | trailing blade to frame span in shaving |
| | direction |
| 56 | lower portion of blade support |
| 58 | radius bend portion |
| 62 | top side of blade support member |
| 64 | inner surface of blade support |
| 66 | outer surface of blade support |
| 70 | inward blade mounting portion |
| 71 | outward blade mounting portion |
| 72 | rounded front end of blade support |
| 80 | base portion |
| 82 | curvilinear portion |
| 84 | cutting edge portion |

1. A razor cartridge comprising:
a housing, wherein the housing comprises a group of cutting members arranged between a trailing longitudinal side and a leading longitudinal side along a first shaving direction (S);
wherein the group of cutting members includes at least two forward facing blades, forward facing blades being characterized by facing in the first shaving direction (S) of the razor cartridge;
wherein the group of cutting members includes at least one backward facing blade, a backward facing blade being characterized by facing opposite to the first shaving direction (S) of the razor cartridge; and
wherein the at least one backward facing blade is placed between the at least two forward facing blades, or
wherein the at least one backward facing blade is the cutting member closest to the leading longitudinal side.

2. The razor cartridge according to claim 1, wherein the group of cutting members comprises exactly three cutting members, of which two cutting members are forward facing blades and one cutting member is a backward facing blade.

3. The razor cartridge according to claim 2, wherein the first and third cutting members seen from the leading longitudinal side are forward facing blades and the second cutting member is a backward facing blade.

4. The razor cartridge according to claim 1, wherein the group of cutting members comprises two forward facing blades and two backward facing blades.

5. The razor cartridge according to claim 4, wherein the first and fourth cutting members seen from the leading longitudinal side are forward facing blades and the second and third cutting members are backward facing blades.

6. The razor cartridge according to claim 4, wherein the first, and third cutting members are forward facing blades and the second and fourth cutting members are backward facing blades.

7. The razor cartridge according to claim 4, wherein at least two backward facing blades are placed between the at least two forward facing blades.

8. The razor cartridge according to claim 1, wherein at least one of the cutting members of the group of cutting members, comprises an inward blade support having an inward blade mounting portion disposed on an inner surface of the inward blade support that, in use, faces away from a shaving plane, and an inward blade attached to the inward blade mounting portion.

9. The razor cartridge according to claim 1, wherein at least one of the cutting members of the group of cutting members comprises an outward blade support having an outward blade mounting portion disposed on an outward surface of the outward blade support that, in use, faces towards a shaving plane, and an outward blade attached to the outward blade mounting portion.

10. The razor cartridge according to claim 1, wherein at least one of the cutting members of the group of cutting members, comprises an integral blade, wherein the integral blade is a backward facing blade.

11. The razor cartridge according to claim 1,
wherein the span between the tip of forward facing blade and the tip of the next backward facing blade in the first shaving direction, is between about 0.45 mm to about 0.80 mm.

12. The razor cartridge according to claim 1,
wherein the span between the tip of forward facing blade and the tip of the next backward facing blade in the first shaving direction, is between about 0.55 mm to about 0.70 mm.

13. The razor cartridge according to claim 1,
wherein the span between the tip of the foremost forward facing blade in the first shaving direction and the edge of the leading longitudinal side facing towards said forward facing blade, is between about 4.0 mm to about 6.0 mm.

14. The razor cartridge according to claim 1,
wherein the span between the tip of the foremost forward facing blade in the first shaving direction and the edge of the leading longitudinal side facing towards said forward facing blade, is between about 4.5 mm to about 5.5 mm.

15. The razor cartridge according to claim 1,
wherein the span between the tip of the foremost forward facing blade in the first shaving direction and the edge of the leading longitudinal side facing towards said forward facing blade, is between about 5.1 mm to about 5.3 mm.

16. The razor cartridge according to claim 1,
wherein the angle between the cutting-edge axis of at least one blade, in particular the backward facing blade, and the cutting edge plane, is between about −10° to about 15°.

17. The razor cartridge according to claim 1,
wherein the angle between the cutting-edge axis of at least one blade, in particular the backward facing blade, and the cutting edge plane, is between about −5° to about 10°.

18. A shaving razor assembly comprising:
a razor handle;
the razor cartridge according to claim 1, wherein the razor cartridge is either releasably attached to the razor handle via a pivotable or non-pivotable connection, integrally formed with the razor handle via a non-pivotable connection, or integrally formed with the razor handle via a pivotable connection.

19. A kit of parts comprising:
a razor handle; and
a razor cartridge holder comprising a plurality of the razor cartridge according to claim 1.

20. A razor cartridge comprising:
a housing, wherein the housing comprises a group of cutting members arranged between a trailing longitudinal side and a leading longitudinal side along a first shaving direction (S);
wherein the group of cutting members includes at least two forward facing blades, forward facing blades being characterized by facing in the first shaving direction (S) of the razor cartridge;
wherein the group of cutting members includes at least one backward facing blade, a backward facing blade being characterized by facing opposite to the first shaving direction (S) of the razor cartridge; and
wherein the at least one backward facing blade is the cutting member closest to the leading longitudinal side
